(19) United States
(12) Patent Application Publication
(10) Pub. No.: US 2025/0390997 A1
(43) Pub. Date: Dec. 25, 2025

(54) IMAGE RESTORATION METHOD AND APPARATUS, AND ELECTRONIC DEVICE

(71) Applicant: BEIJING ZITIAO NETWORK TECHNOLOGY CO., LTD., Beijing (CN)

(72) Inventor: Qianqian WANG, Beijing (CN)

(21) Appl. No.: 18/877,752

(22) PCT Filed: Sep. 5, 2023
(86) PCT No.: PCT/CN2023/117018

§ 371 Date: Dec. 20, 2024

(30) Foreign Application Priority Data
Sep. 6, 2022 (CN) 202211098607.9

(51) Int. Cl. G06T 5/77; G06V 10/25

(52) U.S. Cl. CPC G06T 5/77; G06V 10/25

(57) ABSTRACT

Embodiments of the present disclosure provide an image inpainting method, apparatus and an electronic device. The image inpainting method includes: acquiring a first image which is obtained by processing a target object in an original image; determining a first area to be inpainted in the first image, the first area is at least a partial area of the target object; acquiring a target semantic graph corresponding to the first image; and inpainting the first area based on the target semantic graph to obtain a second image after inpainted. Therefore, the semantic graph of the image to be inpainted which contains richer semantic information is considered, thus, the image can be inpainted based on the richer semantic information. Residual traces of the original image in the inpainted image are reduced, the boundaries of different semantic areas are clear, the textures are richer, and the image is more real.

This application claims the priority of the Chinese patent application No. 202211098607. 9 filed on Sep. 6, 2022, the entire contents of which are incorporated herein by reference.

### TECHNICAL FIELD

Embodiments of the present disclosure relate to an image inpainting method and apparatus, and an electronic device.

### BACKGROUND

Artificial intelligence technology is increasingly being used in the field of images, and it is often used for inpainting damaged original images, or removing covers in original images, and generating new images. Currently, in the new images obtained by processing the original images with related technologies, there will be residual traces of original images remained in the processed areas, resulting in poor image quality. Therefore, a solution is needed to inpaint the modified areas in the image.

### SUMMARY

The present disclosure provides an image inpainting method and apparatus, and an electronic device.

According to a first aspect, an image inpainting method is provided. The method includes:
acquiring a first image, wherein the first image is obtained by processing a target object in an original image;
determining a first area to be inpainted in the first image, wherein the first area is at least a partial area of the target object;
acquiring a target semantic graph corresponding to the first image; and
inpainting the first area based on the target semantic graph to obtain a second image after inpainted.

According to a second aspect, an image inpainting apparatus is provided. The apparatus includes:
a first acquisition module, configured to acquire a first image, wherein the first image is obtained by processing a target object in an original image;
a determination module, configured to determine a first area to be inpainted in the first image, wherein the first area is at least a partial area of the target object;
a second acquisition module, configured to acquire a target semantic graph corresponding to the first image; and
an inpainting module, configured to inpaint the first area based on the target semantic graph to obtain a second image after inpainted.

According to a third aspect, a computer-readable storage medium is provided. A computer program is stored on the storage medium, the computer program, when is executed in a computer, causes the computer to implement the above-mentioned method.

According to a fourth aspect, an electronic device is provided. The electronic device includes: a memory, a processor and a computer program stored on the memory and executable on the processor, wherein the processor executes the program to implement the above-mentioned method.

It should be understood that the above general description and the subsequent detailed description are only exemplary and explanatory, and cannot limit the present disclosure.

### BRIEF DESCRIPTION OF DRAWINGS

In order to more clearly illustrate the technical solution of the disclosed embodiments, a brief introduction will be given to the accompanying drawings required for the description of the embodiments. It is obvious that the accompanying drawings described below are only some of the embodiments recorded in the present disclosure. For those skilled in the art, other drawings can be obtained based on these drawings without creative labor.

FIG. 1 is a schematic diagram of an image inpainting scenario shown according to an exemplary embodiment of the present disclosure;

FIG. 2 is a flowchart of an image inpainting method shown according to an exemplary embodiment of the present disclosure;

FIG. 3 is a flowchart of another image inpainting method shown according to an exemplary embodiment of the present disclosure;

FIG. 4 is a block diagram of an image inpainting apparatus shown according to an exemplary embodiment of the present disclosure;

FIG. 5 is a schematic block diagram of an electronic device provided by some embodiments of the present disclosure;

FIG. 6 is a schematic block diagram of another electronic device provided by some embodiments of the present disclosure; and

FIG. 7 is a schematic diagram of a storage medium provided by some embodiments of the present disclosure.

### DETAILED DESCRIPTION

In order to enable personnel in this technical field to better understand the technical solutions disclosed in the present disclosure, a clear and complete description of the technical solutions in the present disclosure will be provided below in conjunction with the accompanying drawings. Obviously, the described embodiments are only a part of the embodiments disclosed in the present disclosure, not all of them. Based on the embodiments disclosed in the present disclosure, all other embodiments obtained by ordinary technical personnel in the field without creative labor should fall within the protection scope of the present disclosure.

When referring to the accompanying drawings, unless otherwise indicated, the same reference numbers in different drawings represent the same or similar elements. The implementations described in the following exemplary embodiments do not represent all embodiments consistent with the present disclosure. On the contrary, they are only examples of devices and methods consistent with some aspects of the present disclosure as described in the accompanying claims.

The terms used in the present disclosure are for the purpose of describing specific embodiments only and are not intended to limit the present disclosure. The singular forms of “one”. “said”, and “this” used in the present disclosure are also intended to include the majority form, unless the context clearly indicates otherwise. It should also be understood that the term “and/or” used in herein refers to and includes any or all possible combinations of one or more associated listed items.

It should be understood that although the terms first, second, third, etc. may be used in the present disclosure to describe various information, these terms should not be limited to them. These terms are only used to distinguish information of the same type from each other. For example, without departing from the scope of the present disclosure, the first information may also be referred to as the second information, and similarly, the second information may also be referred to as the first information. Depending on the context, the word “if”' used herein can be interpreted as “when” or “during” or “in response to a determination”.

Artificial intelligence technology is increasingly being used in the field of images, and it is often used for inpainting damaged original images, or removing covers in original images, and generating new images. For example, long hair of a person in a person image is changed into short hair, or trees or buildings in a landscape image are removed. Currently, in the new images obtained by processing the original images with related technologies, there will be residual traces of original images remained in the processed areas, resulting in poor image quality. For example, by taking that the long hair of the person in the image is changed into short hair as an example, in a covered area exposed after removing the long hair, there will be residual hair, unclear boundaries of covered clothes, abnormal colors, and other problems. Therefore, a solution is needed to inpaint the modified area in the image.

According to an image inpainting solution provided by the present disclosure, at least part of the modified area in an image to be inpainted is inpainted through a semantic graph corresponding to the image to be inpainted, and therefore the image with a better display effect is obtained. According to the solution provided by the embodiments, in the process of inpainting the modified area in the image to be inpainted, the semantic graph of the image to be inpainted which contains richer semantic information is considered, thus, the image to be inpainted can be inpainted based on the richer semantic information. Residual traces of the original image in the inpainted image are reduced, the boundaries of different semantic areas are clear, the textures are richer, and the image is more real.

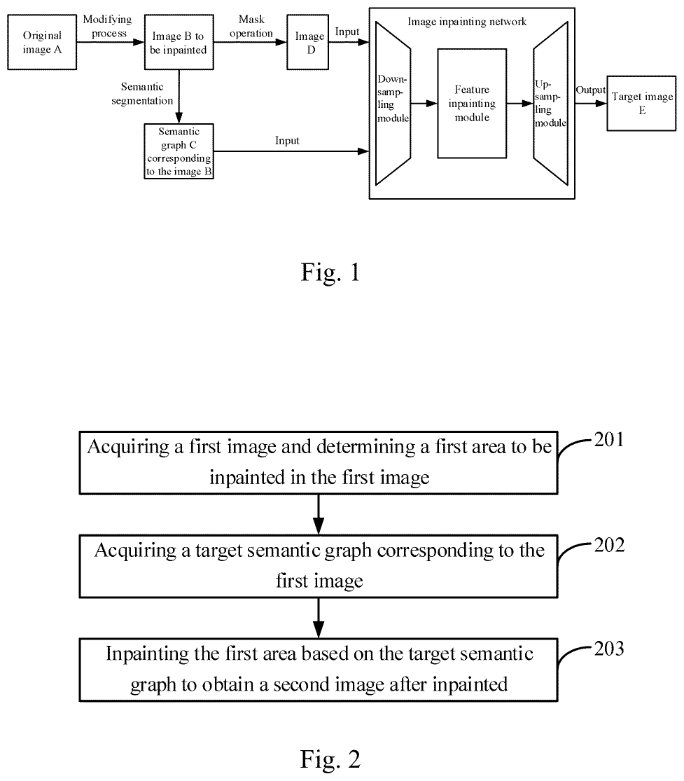

Referring to FIG. 1, it is a schematic diagram of an image inpainting scenario shown according to an exemplary embodiment by the present disclosure. Referring to FIG. 1, the solution of the present disclosure is schematically described below in combination with a complete specific application example. The application example describes a specific image inpainting process.

As shown in FIG. 1, an original image A is an image with a cover to be removed or having a missing area, and an image B can be obtained after the original image A is modified (such as cover removing or missing area filling). Because a modified area a in the image B has the problems of large texture detail loss, unclear boundary and the like, further inpainting process is needed to be carried out for the area a of the image B. Specifically, semantic segmentation processing can be carried out on the image B to obtain a semantic graph C corresponding to the image B, and information of the area a can be acquired. And then, a mask operation is carried out on the image B according to the information of the area a to assign pixel points of the area a in the image B as the value of 0, so as to obtain an image D. The image D and the semantic graph C are inputted into a pre-trained image inpainting network, and image inpainting process (or referred to as image retouching) is carried out on the area a by the image inpainting network.

It is to be noted that the semantic graph C used here is a semantic graph corresponding to the image B, and the semantic graph is essentially different from the semantic graph corresponding to the original image A. Because the information of the area to be modified in the original image A is seriously lost, the semantic graph corresponding to the original image A is lack of semantic information of the area to be modified.

In the image inpainting network, the image D can be processed through a down-sampling module, so that down-sampling is carried out on the image D, and image features of the image D are extracted. For example, the down-sampling module can be composed of a plurality of convolutional layers, and convolutional processing can be carried out on the image D through the convolutional layers in sequence. Moreover, based on the semantic graph C, semantic correction can be carried out on the convolutional processing result after each convolutional processing. Specifically, two parameters α and β (α and β are vectors) can be obtained through learning of two different convolutional layers based on the semantic graph C, and semantic correction is carried out on a feature graph obtained through convolutional processing with the parameters α and β. For example, semantic correction can be carried out according to the semantic graph C in a SPADE space adaptive manner. After convolutional processing by the plurality of convolutional layers, a feature graph to be inpainted can be obtained, and then the feature graph to be inpainted is processed by an image inpainting module.

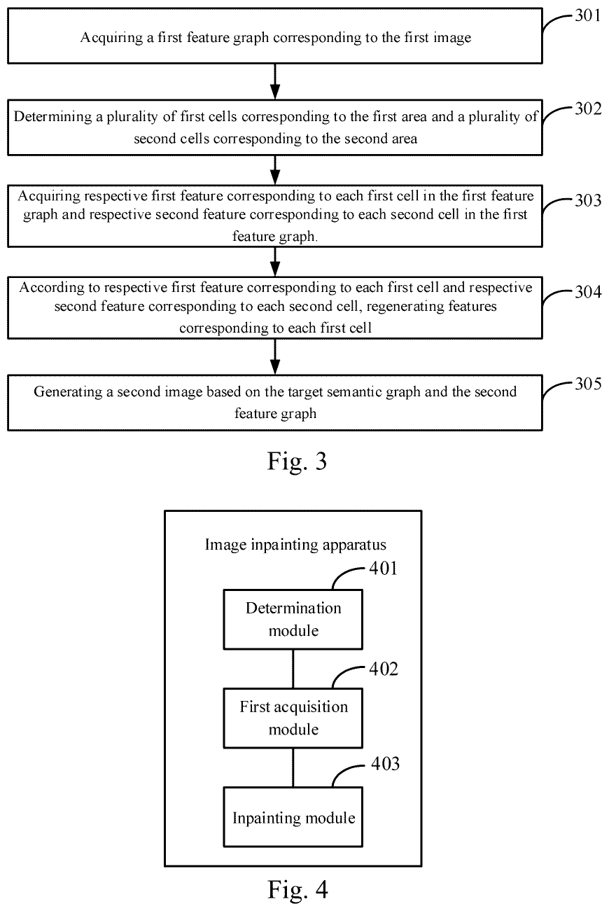

Specifically, an unknown area corresponding to the area a in the feature graph to be inpainted can be divided into a plurality of unknown sub-areas according to semanteme based on the semantic graph C, such that each unknown sub-area only corresponding to one semanteme. A known area except the unknown area in the feature graph to be inpainted is determined, the known area is also divided into a plurality of known sub-areas, and each known sub-area only corresponds to one semanteme. For any unknown sub-area, an initial feature corresponding to the unknown sub-area in the feature graph to be inpainted can be determined, and the feature of the unknown sub-area is reconstructed by the known sub-area with the same semantics as the unknown sub-area, so as to obtain a reconstructed feature (the specific process refers to embodiment as shown in FIG. 3). Feature fusion is carried out on the initial feature and the reconstructed feature by stacking processing to obtain an inpainted feature graph.

The inpainted feature graph is processed by up-sampling, so that the inpainted feature graph is up-sampled, and the inpainted feature graph is converted into an inpainted target image E. For example, an up-sampling module can be composed of a plurality of deconvolutional layers, and the inpainted feature graph can be subjected to deconvolutional processing through the deconvolutional layers in sequence. Similarly, based on the semantic graph C, semantic correction can be carried out on the deconvolutional processing result after each deconvolutional processing.

It is to be noted that in a stage of training the above image inpainting network, a complete and real image can be selected as a sample image, and a semantic graph corresponding to the sample image is acquired. A part of area (such as an area with rich semantic information) in the sample image is selected for mask processing. The semantic graph corresponding to the sample image and the image subjected to mask processing are inputted into the image inpainting network to be trained, and a prediction image outputted by the image inpainting network is acquired. Prediction loss is computed based on the prediction image and the sample image, and network parameters of the image inpainting network are adjusted according to the prediction loss, thereby training the image inpainting network.

The present disclosure is described in detail in combination with specific embodiments.

FIG. 2 is a flowchart of an image inpainting method shown according to an exemplary embodiment. An execution subject of the method can be any device, platform, server or device cluster with computing and processing capabilities. The method includes the following steps:

As shown in FIG. 2, step 201: acquiring a first image, and determining a first area to be inpainted in the first image.

In the embodiments, the first image is obtained by processing a target object in the original image, and the first area is at least a partial area of the target object. In one scenario, the first image can be an image obtained by removing a cover in the original image (the target object is the cover), and the first area can be at least part of the area corresponding to the removed cover. For example, in response to changing long hair in the person image into short hair, part of the hair tail in the image needs to be removed. The image obtained after hair tail removing is the first image, and the area where the hair tail is removed is the first area. In this scenario, the area to be inpainted in the image generally contains various semantemes, the proportion of the area to be inpainted in the image is relatively large, and there is less known information that can be referenced. Therefore, the effect that can be achieved by repairing through the image inpainting provided by the embodiments is more significant.

In another scenario, the first image can also be an image obtained by inpainting and filling a damaged or information-missing area in the original image, and the first area can be at least a part of the damaged or information-missing area (the target object is a damaged or information-missing part). For example, an old photo with a seriously damaged partial area is scanned to be served as an original image. The area corresponding to the damaged part in the original image is inpainted to obtain the first image, in which the inpainted area is the first area. It is to be understood that the solution can also be applied to other scenarios, and the embodiments are not limited in specific application scenarios.
Step 202: acquiring a target semantic graph corresponding to the first image; and step 203: inpainting the first area based on the target semantic graph to obtain a second image after inpainted.

In the embodiments, semantic segmentation can be carried out on the first image to obtain a target semantic graph corresponding to the first image, features corresponding to the first area in the first image are inpainted based on the target semantic graph to obtain new features corresponding to the inpainted first area, and then the inpainted second image is generated based on the new features corresponding to the first area.

It is to be noted that the semantic graph used here is a semantic graph corresponding to the modified first image rather than the semantic graph of an unmodified original image. Because there are many semantic information missing in the area to be modified in the original image, the semantic information of the area to be modified in the modified first image is richer.

In one implementation, based on the target semantic graph, the features corresponding to the first area in the first image can be inpainted by the features corresponding to the second area in the first image (the area other than the first area in the first image). For example, according to the target semantic graph and the features corresponding to the second area, the inpainting parameters are obtained, and the features corresponding to the first area are inpainted by the inpainting parameters (such as adding or multiplying the inpainting parameters with the features corresponding to the first area, or performing a preset operation).

In another implementation, a first feature graph corresponding to the first image can also be acquired, and based on the target semantic graph, the features corresponding to the first area are regenerated by the features corresponding to the second area in the first feature graph, so as to obtain a second feature graph. A second image is acquired based on the second feature graph. For example, for the first area corresponding to one semanteme, the features corresponding to the first area can be regenerated by the features corresponding to the closest second area in surrounding preset range and having the same semantics in the first feature graph.

Optionally, a first cell corresponding to the first area can be determined, and at least one second cell (the second cell corresponds to the second area) with the same semantics as the first cell is determined based on the target semantic graph. And then, features corresponding to the first cell are regenerated according to the features of the second cell. According to the implementation, the first area to be inpainted is further subdivided into the first cell, and the features corresponding to the first cell are regenerated by the features of the second cell with the same semantics as the first cell, such that the quality of the inpainted image can be improved, and the semantic boundary is clearer and more natural.

According to the image inpainting method provided by the present disclosure, at least part of the modified area in the image to be inpainted is inpainted through the semantic graph corresponding to the image to be inpainted, such that the image with a better display effect can be obtained. According to the solution provided by the embodiments, in the process of inpainting the modified area in the image to be inpainted, the semantic graph of the image to be inpainted which contains richer semantic information is considered, thus, the image to be inpainted can be inpainted based on the richer semantic information. Residual traces of the original image in the inpainted image are reduced, the boundaries of different semantic areas are clear, the textures are richer, and the image is more real.

It is to be noted that, although there are a plurality of methods for image inpainting in some examples, the quality of the inpainted image is poor, there are residual traces of the original image in the inpainted image, and the boundaries of different semantic areas are blurred and unnatural. Those skilled in the art did not find the problem because they did not consider the influence of the semantic information of the inpainted image on the inpainting effect during inpainting. There may be many reasons for the poor image inpainting effect, and it is difficult for those skilled in the art to think of the above reasons without hard work. The technical solution of the present disclosure takes into account the influence of the semantic information of the inpainted image on the inpainting effect. Therefore, the above technical problems can be discovered and solved.

The solution of the present disclosure is illustratively described in combination with two complete application examples.

One application scenario can be as follows: long hair of a person in an original image 1 is changed into short hair, that is, the tail part of the long hair in the original image 1 is removed to obtain an image 2. However, because the removed area covered by the long hair in the image 2 has more texture loss details, the image 2 needs to be further inpainted.

Specifically, firstly, the image 2 can be acquired as the first image, and a modified area f in the image 2 is determined as the first area. The area f can be at least a part of the area corresponding to the removed tail part. An area g except the area f in the image 2 can be used as the second area (for example, the area g includes clothes, skin, and background around the hair). And then, the semantic graph C corresponding to the image 2 is acquired as the target semantic graph. Semantic division is carried out on the area f and the area g according to the semantic graph C, and a plurality of sub-areas f′ corresponding to different semantemes in the area f and a plurality of sub-areas g′ corresponding to different semantemes in the area g are determined.

And then, the sub-area f′ is inpainted by the sub-area g′ with the same semanteme. For example, the sub-area f1′ corresponding to the skin semanteme is inpainted by the sub-area g1′ corresponding to the skin semanteme; the sub-area f2′ corresponding to the clothes semanteme is inpainted by the sub-area g2′ corresponding to the clothes semanteme; and the sub-area f3′ corresponding to the clothes semanteme is inpainted by the sub-area g3′ corresponding to the clothes semanteme. And finally, an inpainted image 3 can be obtained.

Another application scenario can be as follows: a partially damaged old photo is scanned to obtain an original image 4, and a missing area in the original image 4 is filled to obtain an image 5. However, because the missing area filled in the image 5 has more texture loss details, the image 5 needs to be further inpainted.

Specifically, firstly, the image 5 can be acquired as the first image, and at least part of an area w corresponding to the missing area filled in the image 5 is determined to be the first area. And an area v except the area w in the image 5 is treated as the second area. And then, a semantic graph D corresponding to the image 5 is acquired as the target semantic graph. Semantic division is carried out on the area w and the area v according to the semantic graph D, and a plurality of sub-areas w′ corresponding to different semantemes in the area w and a plurality of sub-areas v′ corresponding to different semantemes in the area v are determined. Then, the sub-areas w′ are inpainted by the sub-areas v′ with the same semantics. Finally, an inpainted image 6 can be obtained.

FIG. 3 is a flowchart of another image inpainting method shown by an exemplary embodiment, and the embodiment describes a process of inpainting the first area, including the following steps:

As shown in FIG. 3, step 301: acquiring a first feature graph corresponding to a first image.

In the embodiments, the features of the first image can be extracted firstly so as to obtain the first feature graph. For example, the first image can be directly inputted to the down-sampling module (such as being formed by the plurality of convolutional layers) so as to obtain the first feature graph outputted by the down-sampling module. For another example, mask processing can also be performed on the first image using the first area firstly, and the image after mask processing is processed. Specifically, mask processing is performed on the first image using the first area, and the pixel points of the first area in the first image can be assigned to be value 0. Then, the image after mask processing is inputted to the down-sampling module. Optionally, convolutional processing can be performed on the image after mask processing by the plurality of convolutional layers, and semantic correction can be performed on the result of convolutional processing based on the target semantic graph corresponding to the first image after processing by the convolutional layers so as to obtain the first feature graph.

For example, semantic correction can be carried out by the target semantic graph after each convolutional layer processing. Semantic correction can be carried out once by utilizing the target semantic graph after multiple times of convolutional layer processing. It is to be understood that the specific number of times of semantic correction is not limited in the embodiments. After convolutional processing by the plurality of convolutional layers, the first feature graph corresponding to the first image can be obtained. According to the embodiments, in the process of extracting the features of the first image, the extracted features are corrected by the semantic information, so that the extraction and generation of subsequent features are conveniently guided with semanteme, and the boundaries of different semantic areas in the inpainted image are clearer, and the textures are richer.
Step 302: determining a plurality of first cells corresponding to the first area and a plurality of second cells corresponding to the second area. Step 303: acquiring respective first feature corresponding to each first cell in the first feature graph and respective second feature corresponding to each second cell in the first feature graph.

In the embodiments, each feature point in the first feature graph corresponds to the pixel point in the first image, and in response to performing down-sampling processing, the number of the feature points in the first feature graph is smaller than the number of the pixel points in the first image. Therefore, each feature point has the corresponding pixel point in the first image. A semantic tag can be added for each pixel point in the first image in advance based on the target semantic graph, and an area mark (used for indicating whether the pixel point belongs to the first area or the second area) is added for each pixel point. Therefore, after the first feature graph is obtained, each feature point in the first feature graph also has the same semantic tag and area mark as the corresponding pixel point.

Then, the first feature graph can be uniformly divided into a plurality of cells, the cells can be square, rectangular or the like, and each cell has the same size and includes the same number of feature points. For example, each cell can include m×n feature points. A plurality of first cells corresponding to the first area and a plurality of second cells corresponding to the second area can be determined according to the area marks corresponding to the feature points. For example, for a cell, in response to that the cell includes a feature point corresponding to the first area, the cell can be determined to be one first cell. In response to that the cell does not include feature points corresponding to the first area (namely, all the included feature points correspond to the second area), the cell can be determined to be one second cell.

In addition, the semanteme corresponding to each cell can be determined according to the semantic tags of the feature points included in each cell. For example, in response to that the semantic tags of the feature points included in the cell are the same, the semanteme indicated by the semantic tag is the semanteme corresponding to the cell. In response to that the semantic tag of the feature point included in the cell is different, the semanteme indicated by the semantic tags with the maximum number can be used as the semanteme corresponding to the cell.

Then, each first feature (such as the feature value of the feature point in the first cell) corresponding to each first cell in the first feature graph and each second feature corresponding to each second cell in the first feature graph can be acquired.
Step 304: according to respective first feature corresponding to each first cell and respective second feature corresponding to each second cell, regenerating the features corresponding to each first cell to obtain a second feature graph.

Specifically, at least one second cell with the same semantics corresponding to each first cell can be determined according to the semanteme corresponding to each first cell and each second cell. The features corresponding to the first cell can be regenerated according to the second features of the second cell corresponding to any first cell in the first feature graph.

For example, the first feature graph includes cells A1m, A2m, A3n . . . , B1m, B2m, B3n, B4n, B5m, B6n . . . , in which A represents the first cell, B represents the second cell, and m and n represent two different semantemes respectively. Therefore, the second cell with the same semantics as the cell A1m includes B1m, B2m and B5m, and the cells B1m, B2m and B5m can be used for regenerating features corresponding to the cell A1m. The second cell with the same semantics as the cell A2m also includes B1m, B2m and B5m, and the cells B1m, B2m and B5m can be used for regenerating features corresponding to the cell A2m. The second cell with the same semantics as the cell A3n includes B3n, B4n and B6n, and thus, the cells B3n, B4n and B6n can be used for regenerating features corresponding to the cell A3n.

Specifically, for any first cell, the features corresponding to the first cell can be regenerated by the following steps: computing a similarity between the first cell and each second cell with the same semantics, determining a weight of the second feature corresponding to each second cell according to the similarity, computing the weighted sum of the second features based on the weight, and regenerating the features corresponding to the first cell through the weighted sum. Optionally, the similarity between the first cell and the second cell can be computed in an inner product method. It is to be understood that any method which is known in the field and can be used for computing the image similarity between the futures can be applied to the embodiments, and the embodiments does not limit the specific method for computing image similarity.

For example, the similarities between the cell A1m and the cells B1m, B2m and B5m with the same semantics are S1, S2 and S3 respectively, and S1, S2 and S3 can be normalized to obtain weights w1, w2 and w3. The second features corresponding to the cells B1m, B2m and B5m in the first feature graph are V1, V2 and V3 respectively. The weighted sum of the second features can be computed according to the weight to obtain a reconstructed feature V′, in which, V′=w1V1+w2V2+w3V3. Optionally, a first feature V″ corresponding to the cell A1m in the first feature graph can be acquired, and a stacking processing is performed on V′ and V″ to obtain the feature V corresponding to the regenerated cell A1m.

The larger the similarity between the first cell and the second cell with the same semantics is, the closer the corresponding features are, so that the weight determined according to the similarity can better reflect the association relationship between the first cell and the second cell. According to the embodiments, the features corresponding to the first cell are regenerated based on the similarity between the first cell and the second cell, thus, the image obtained based on the regenerated features is more real and natural.
Step 305: generating a second image based on the target semantic graph and the second feature graph.

In the embodiments, the second feature graph can be inputted into the up-sampling module, for example, the up-sampling module can be composed of a plurality of deconvolutional layers, deconvolutional processing can be carried out on the second feature graph, and optionally, after processing by the deconvolutional layers, semantic correction can be carried out on the result of deconvolutional processing based on the target semantic graph so as to obtain the second image. For example, semantic correction can be carried out once by the target semantic graph after each deconvolutional layer processing. The target semantic graph can also be used for carrying out semantic correction once after multiple times of deconvolutional layer processing. It is to be understood that the embodiments do not limit the specific number of times of semantic correction. According to the embodiments, in the up-sampling process, the up-sampling processing result is corrected by the semantic information, so that the generation of a subsequent image is guided with the semantics, and the boundaries of different semantic areas in the obtained image are clearer, and the textures are richer.

According to the embodiments, when inpainting an images, the correlation between the known area (namely the second area) and the unknown area (namely the first area) in the image is considered, the correlation relationship between the known area and the unknown area is determined through semantics, under the guidance of rich semantics, the features of the unknown area are regenerated by the features of the known area which has the same semantics with the unknown area, and therefore the inpainted image is obtained, and the quality of the inpainted image can be further improved.

It is to be noted that although the operations of the method of the embodiments of the present disclosure are described in a specific order in the above embodiments, it does not require or imply that the operations must be performed in this specific order, or that all the operations shown must be performed to achieve the desired results. On the contrary, the steps described in the flowchart can change the order of execution. Additionally or alternatively, some steps can be omitted, multiple steps can be combined into one step for execution, and/or one step can be decomposed into multiple steps for execution.

Corresponding to the embodiments of the image inpainting method, the present disclosure further provides embodiments of an image inpainting apparatus.

As shown in FIG. 4, FIG. 4 is a block diagram of an image inpainting apparatus shown according to an exemplary embodiment of the present disclosure, and the apparatus may include: a determination module 401, a first acquisition module 402 and an inpainting module 403.

The determination module 401 is configured to acquire a first image, and determine a first area to be inpainted in the first image; and the first image is obtained by processing a target object in the original image, and the first area is at least a partial area of the target object.

The first acquisition module 402 is configured to acquire a target semantic graph corresponding to the first image.

The inpainting module 403 is configured to inpaint the first area based on the target semantic graph to obtain a second image after inpainted.

In some implementations, the above processing includes an operation of removing the target object.

In some implementations, the inpainting module 403 may includes: a first acquisition submodule, an inpainting submodule and a second acquisition submodule (not shown in the figure).

The first acquisition submodule is configured to acquire the first feature graph corresponding to the first image.

The inpainting submodule is configured to regenerate the features corresponding to the first area by the features corresponding to the second area in the first feature graph based on the target semantic graph, so as to obtain a second feature graph; and the second area is an area except the first area in the first image.

The second acquisition submodule is configured to acquire the second image based on the second feature graph.

In some implementations, the first acquisition submodule can acquire the first feature graph corresponding to the first image by the following steps: performing mask processing on the first image using the first area, performing down-sampling processing on the image subjected to mask processing, and performing semantic correction on the result of down-sampling processing based on the target semantic graph so as to obtain the first feature graph.

In some implementations, the inpainting submodule may include: a determination submodule and a generation submodule (not shown in the figure).

The determination submodule is configured to determine a first cell corresponding to the first area, and determine at least one second cell with the same semantics as the first cell based on the target semantic graph; and the second cell corresponds to the second area.

The generation submodule is configured to regenerate features corresponding to the first cell according to the features corresponding to the second cell in the first feature graph.

In some implementations, the generation submodule is configured to: acquire each first feature corresponding to each first cell in the first feature graph and respective second features corresponding to each second cell in the first feature graph, and regenerate the features corresponding to the first cell according to the first feature and the second feature.

In some implementations, the second acquisition submodule is configured to: generate a second image based on the target semantic graph and the second feature graph.

In some implementations, the second acquisition submodule generates the second image based on the target semantic graph and the second feature graph by the following steps: performing up-sampling processing on the second feature graph, and performing semantic correction on the result of the up-sampling processing based on the target semantic graph so as to obtain the second image.

In some implementations, the generation submodule regenerates the features corresponding to the first cell according to the first feature and the second feature by the following steps: computing a similarity between the first feature and each second feature, and regenerating the features corresponding to the first cell based on the similarity.

In some implementations, the generation submodule regenerates the features corresponding to the first cell based on the similarity by the following steps: determining a weight corresponding to each second feature based on the similarity, computing a weighted sum of the second features, and performing a stacking processing on the weighted sum and the first feature to obtain the features corresponding to the first cell.

For the apparatus embodiment, since it basically corresponds to the method embodiment, the relevant parts can refer to the description of the method embodiment. The apparatus embodiment described above is only schematic, in which the units described as separate components may or may not be physically separated, and the components displayed as units may or may not be physical units, that is, they may be located in one place, or they may be distributed on a plurality of network units. Some or all of the modules may be selected according to actual needs to achieve the purpose of the embodiment solution of the present disclosure. Those who have common skill in the art can understand and implement it without creative labor.

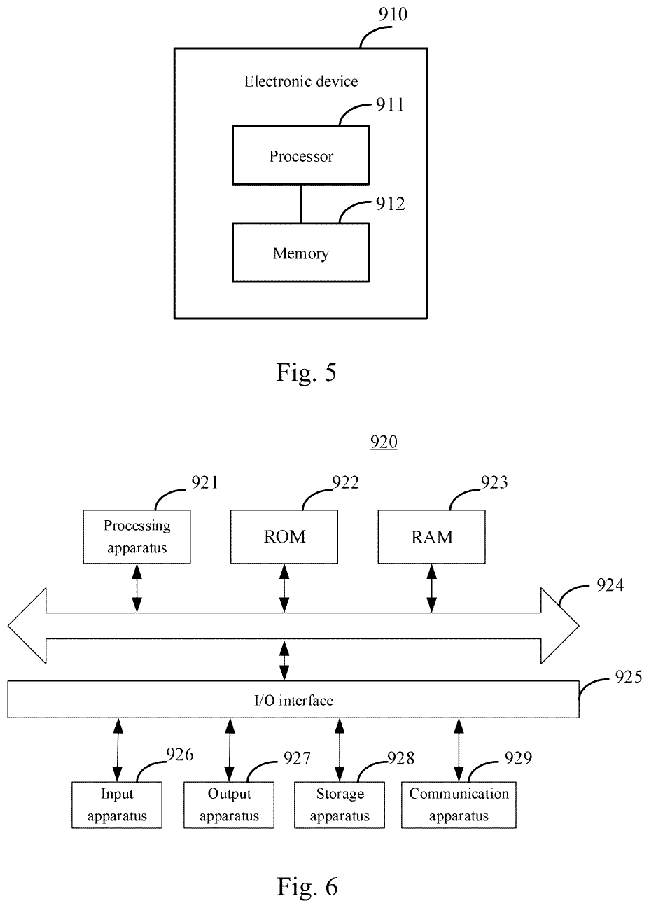

FIG. 5 is a schematic block diagram of an electronic device provided by some embodiments of the present disclosure. As shown in FIG. 5, an electronic device 910 includes a processor 911 and a memory 912, and can be used for realizing a client or a server. The memory 912 is configured to non-instantaneously store computer-executable instructions (such as one or more computer program modules). The processor 911 is configured to run the computer-executable instructions, and in response to that the computer-executable instructions being run by the processor 911, one or more steps in the above image inpainting method can be executed, and thus the above image inpainting method is implemented. The memory 912 and the processor 911 can be interconnected through a bus system and/or other forms of connecting mechanisms (not shown).

For example, the processor 911 can be a Central Processing Unit (CPU), a Graphics Processing Unit (GPU) or other forms of processing units with data processing capability and/or program execution capability. For example, the Central Processing Unit (CPU) can be X86 or ARM architecture. The processor 911 can be a universal processor or a special processor, and can control other components in the electronic device 910 to execute desired functions.

For example, the memory 912 can include any combination of one or more computer program products, and the computer program products can include various forms of computer-readable storage medium, such as volatile memories and/or nonvolatile memories. The volatile memories can include, for example, Random Access Memories (RAM) and/or cache memories. The nonvolatile memories can include, for example, read-only memories (ROM), hard disks, erasable programmable read-only memories (EPROM), portable compact disk read-only memories (CD-ROM), USB memories, and flash memories. One or more computer program modules can be stored on the computer-readable storage medium, and the processor 911 can run the one or more computer program modules to realize various functions of the electronic device 910. Various applications and various data as well as various data used and/or generated by the applications and the like can be stored in the computer-readable storage medium.

It is to be noted that in the embodiments of the present disclosure, the specific functions and technical effects of the electronic device 910 can refer to the description of the above image inpainting method, which will not be repeated here.

FIG. 6 is a schematic block diagram of another electronic device provided by some embodiments of the present disclosure. The electronic device 920 is suitable for implementing, for example, the image inpainting method provided by the embodiments of the present disclosure. The electronic device 920 can be a terminal device and the like, and can be configured to realize the client or server. The electronic device 920 can include but is not limited to mobile terminals such as a mobile phone, a notebook computer, a digital broadcast receiver, a PDA (personal digital assistant), a PAD (tablet personal computer), a PMP (portable multimedia player), a vehicle-mounted terminal (such as a vehicle-mounted navigation terminal), and a wearable electronic device, and immobile terminals such as a digital TV, a desktop computer, and a smart home device. It is to be noted that the electronic device 920 shown in FIG. 6 is only an example, and does not bring any limitation to the functions and the use range of the embodiment of the present disclosure.

As shown in FIG. 6, the electronic device 920 can include a processing apparatus (such as a central processor, and a graphic processor) 921, which can perform various appropriate actions and processing according to a program stored in a read-only memory (ROM) 922 or a program loaded from a storage apparatus 928 to a Random Access Memory (RAM) 923. In the RAM 923, various programs and data required for operation of the electronic device 920 are also stored. The processing apparatus 921, ROM 922 and RAM 923 are connected with one another through a bus 924. An input/output (I/O) interface 925 is also connected to the bus 924.

Generally, the following apparatuses can be connected to the I/O interface 925: an input apparatus 926 including, for example, a touch screen, a touch pad, a keyboard, a mouse, a camera, a microphone, an accelerometer, and a gyroscope, an output apparatus 927 including, for example, a Liquid Crystal Display (LCD), a loudspeaker, and a vibrator, a storage apparatus 928 including, for example, a magnetic tape, and a hard disk, and a communication apparatus 929. The communication apparatus 929 can allow the electronic device 920 to perform wireless or wired communication with other electronic devices to exchange data. Although the electronic device 920 with various devices is shown in FIG. 6, it is to be understood that the electronic device 920 can be alternatively implemented or provided with more or less devices without implementing or being provided with all the shown apparatuses.

For example, according to the embodiments of the present disclosure, the image inpainting method can be implemented as a computer software program. For example, the embodiments of the present disclosure include a computer program product which includes a computer program carried on a non-transient computer-readable medium, and the computer program includes program codes for executing the above image inpainting method. In such embodiment, the computer program can be downloaded and installed from a network through the communication apparatus 929, or installed from the storage apparatus 928, or installed from the ROM 922. In response to that the computer program is executed by the processing apparatus 921, functions defined in the image inpainting method provided by the embodiments of the present disclosure can be realized.

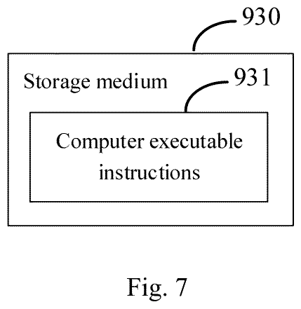

FIG. 7 is a schematic diagram of a storage medium provided by some embodiments of the present disclosure. For example, as shown in FIG. 7, the storage medium 930 can be a non-temporary computer-readable storage medium and is configured to store non-temporary computer-executable instructions 931. When the non-temporary computer-executable instructions 931 are executed by a processor, the image inpainting method provided by the embodiment of the present disclosure can be implemented, for example, when the non-temporary computer-executable instructions 931 are executed by the processor, one or more steps in the above image inpainting method can be executed.

For example, the storage medium 930 can be applied to the electronic device, for example, the storage medium 930 can include a memory in the electronic device.

For example, the storage medium can include a memory card of a smart phone, a storage component of a tablet personal computer, a hard disk of a personal computer, a Random Access Memory (RAM), a read-only memory (ROM), an erasable programmable read-only memory (EPROM), a portable compact disk read-only memory (CD-ROM), a flash memory or any combination of the storage media, and can also be other applicable storage media.

For example, description about the storage medium 930 can refer to description about the memory in the embodiment of the electronic device, which will not be repeated here. Specific functions and technical effects of the storage medium 930 can refer to description about the above image inpainting method, which will not be repeated here.

It should be noted that in the context of the present disclosure, a computer-readable medium may be a tangible medium that contains or stores programs for use by or in combination with an instruction execution system, apparatus, or device. Computer readable media can be computer readable signal media or computer readable storage media, or any combination of the two. Computer readable storage media can include, but are not limited to, electrical, magnetic, optical, electromagnetic, infrared, or semiconductor systems, devices, or any combination thereof. More specific examples of computer-readable storage media may include, but are not limited to, electrical connections with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the present disclosure, a computer-readable storage medium can be any tangible medium containing or storing a program that can be used by an instruction execution system, apparatus, or device, or used in combination with it. In the present disclosure, computer-readable signal media may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can send, propagate, or transmit programs for use by or in combination with instruction execution systems, devices, or equipment. The program code contained on a computer-readable medium can be transmitted using any suitable medium, including but not limited to: wires, optical cables, RF (radio frequency), etc., or any suitable combination of the above.

After considering the present disclosure, technical personnel in this field will easily come up with other implementation schemes of the present disclosure. The present disclosure is intended to cover any variations, uses, or adaptive changes of the present disclosure that follow the general principles of the present disclosure and include common knowledge or customary technical means in the art that are not disclosed in the present disclosure. The embodiments disclosed herein are only considered exemplary, and the true scope and spirit of the disclosure are indicated by the claims.

It should be understood that the present disclosure is not limited to the precise structure described above and shown in the accompanying drawings, and various modifications and changes can be made without departing from its scope. The scope of the present disclosure is limited only by the appended claims.

1. An image inpainting method, comprising:
acquiring a first image, wherein the first image is obtained by processing a target object in an original image;
determining a first area to be inpainted in the first image, wherein the first area is at least a partial area of the target object;
acquiring a target semantic graph corresponding to the first image; and
inpainting the first area based on the target semantic graph to obtain a second image after inpainted.

2. The method according to claim 1, wherein the processing comprises an operation of removing the target object.

3. The method according to claim 1, wherein inpainting the first area based on the target semantic graph to obtain the second image after inpainted, comprises:
acquiring a first feature graph corresponding to the first image;
regenerating features corresponding to the first area by features corresponding to a second area in the first feature graph based on the target semantic graph, so as to obtain a second feature graph, wherein the second area is an area except the first area in the first image; and
acquiring the second image based on the second feature graph.

4. The method according to claim 3, wherein acquiring the first feature graph corresponding to the first image, comprises:
performing mask processing on the first image using the first area, and
performing down-sampling processing on an image subjected to the mask processing, and performing semantic correction on a result of the down-sampling processing based on the target semantic graph, so as to obtain the first feature graph.

5. The method according to claim 3-or 4, wherein regenerating the features corresponding to the first area by the features corresponding to the second area in the first feature graph based on the target semantic graph, comprises:
determining a first cell corresponding to the first area, and determining at least one second cell with same semantics as the first cell based on the target semantic graph, wherein the second cell corresponds to the second area; and
regenerating features of the first cell according to features corresponding to the second cell in the first feature graph.

6. The method according to claim 5, wherein regenerating the features corresponding to the first cell according to the features corresponding to the second cell in the first feature graph, comprises:
acquiring a first feature corresponding to the first cell in the first feature graph and respective second features corresponding to each second cell in the first feature graph; and
regenerating features of the first cell according to the first feature and second features.

7. The method according to claim 3, wherein acquiring the second image based on the second feature graph, comprises: generating the second image based on the target semantic graph and the second feature graph.

8. The method according to claim 7, wherein generating the second image based on the target semantic graph and the second feature graph, comprises:
performing up-sampling processing on the second feature graph, and performing semantic correction on a result of the up-sampling processing based on the target semantic graph so as to obtain the second image.

9. The method according to claim 6, wherein regenerating the features of the first cell according to the first feature and second features, comprises:
computing a similarity between the first feature and each second feature; and
regenerating the features of the first cell based on the similarity.

10. The method according to claim 9, wherein regenerating the features corresponding to the first cell based on the similarity, comprises:
determining a weight corresponding to each second feature based on the similarity, and computing a weighted sum of the second features; and
regenerating the features of the first cell according to the weighted sum.

11. The method according to claim 10, wherein regenerating the features of the first cell according to the weighted sum, comprises:
performing a stacking processing on the weighted sum and the first feature to obtain the features corresponding to the first cell.

12. (canceled)

13. A non-transitory computer-readable storage medium storing instructions that cause a processor to:
acquire a first image, wherein the first image is obtained by processing a target object in an original image;
determine a first area to be inpainted in the first image, wherein the first area is at least a partial area of the target object;
acquire a target semantic graph corresponding to the first image; and
inpaint the first area based on the target semantic graph to obtain a second image after inpainted.

14. An electronic device, comprising a processor and a non-transitory memory with instructions thereon, wherein the instructions upon execution by the processor, cause the processor to:
acquire a first image, wherein the first image is obtained by processing a target object in an original image;
determine a first area to be inpainted in the first image, wherein the first area is at least a partial area of the target object;
acquire a target semantic graph corresponding to the first image; and
inpaint the first area based on the target semantic graph to obtain a second image after inpainted.

15. The electronic device according to claim 14, wherein the processing comprises an operation of removing the target object.

16. The electronic device according to claim 14, wherein inpainting the first area based on the target semantic graph to obtain the second image after inpainted by the processor comprises:
acquiring a first feature graph corresponding to the first image;
regenerating features corresponding to the first area by features corresponding to a second area in the first feature graph based on the target semantic graph, so as to obtain a second feature graph, wherein the second area is an area except the first area in the first image; and
acquiring the second image based on the second feature graph.

17. The electronic device according to claim 16, wherein acquiring the first feature graph corresponding to the first image by the processor comprises:
performing mask processing on the first image using the first area, and
performing down-sampling processing on an image subjected to the mask processing, and performing semantic correction on a result of the down-sampling processing based on the target semantic graph, so as to obtain the first feature graph.

18. The electronic device according to claim 16, wherein regenerating the features corresponding to the first area by the features corresponding to the second area in the first feature graph based on the target semantic graph by the processor comprises:
determining a first cell corresponding to the first area, and determining at least one second cell with same semantics as the first cell based on the target semantic graph, wherein the second cell corresponds to the second area; and
regenerating features of the first cell according to features corresponding to the second cell in the first feature graph.

19. The electronic device according to claim 18, wherein regenerating the features corresponding to the first cell according to the features corresponding to the second cell in the first feature graph by the processor comprises:
acquiring a first feature corresponding to the first cell in the first feature graph and respective second features corresponding to each second cell in the first feature graph; and
regenerating features of the first cell according to the first feature and second features.

20. The electronic device according to claim 16, wherein acquiring the second image based on the second feature graph by the processor comprises: generating the second image based on the target semantic graph and the second feature graph.

21. The non-transitory computer-readable storage medium according to claim 13, wherein inpainting the first area based on the target semantic graph to obtain the second image after inpainted by the processor comprises:
acquiring a first feature graph corresponding to the first image;
regenerating features corresponding to the first area by features corresponding to a second area in the first feature graph based on the target semantic graph, so as to obtain a second feature graph, wherein the second area is an area except the first area in the first image; and
acquiring the second image based on the second feature graph.
